(19) United States
(12) Patent Application Publication
(10) Pub. No.: US 2025/0067709 A1
(43) Pub. Date: Feb. 27, 2025

(54) SETTING METHOD AND SETTING DEVICE

(71) Applicant: SHIMADZU CORPORATION, Kyoto (JP)

(72) Inventors: Tomohiro KAWASE, Kyoto (JP); Satoru WATANABE, Kyoto (JP); Shinichi FUJISAKI, Kyoto (JP)

(73) Assignee: SHIMADZU CORPORATION, Kyoto (JP)

(21) Appl. No.: 18/807,265

(22) Filed: Aug. 16, 2024

(30) Foreign Application Priority Data
Aug. 23, 2023 (JP) 2023-135223

(51) Int. Cl. G01N 30/86

(52) U.S. Cl. CPC G01N 30/8675; G01N 30/8631

(57) ABSTRACT

A processor of a setting device obtains a plurality of pieces of peak information respectively corresponding to a plurality of components, determines whether or not one component of the plurality of components is distinguishable from another component other than the one component based on a value of a first peak parameter indicating a feature of a peak included in each of the plurality of pieces of peak information, sets, to a first identification method that is based on the first peak parameter, an identification method for a component that is distinguishable from the other component based on the first peak parameter among the plurality of components, and sets, to another identification method different from the first identification method, an identification method for a component that is not distinguishable from the other component among the plurality of components based on the first peak parameter.

### CROSS REFERENCE TO RELATED APPLICATIONS

This nonprovisional application is based on Japanese Patent Application No. 2023-135223 filed on Aug. 23, 2023 with the Japan Patent Office, the entire contents of which are hereby incorporated by reference.

### BACKGROUND OF THE INVENTION

### Field of the Invention

The present disclosure relates to: a setting method executable by a computer so as to set an identification method to each of a plurality of components; and a setting device.

### Description of the Background Art

Japanese Patent Laying-Open No. 2023-4872 discloses a data processing system that can automatically associate peaks among a plurality of chromatograms obtained by performing a chromatograph analysis onto the same sample under a plurality of different analysis conditions. In the data processing system of Japanese Patent Laying-Open No. 2023-4872, one of the plurality of chromatograms is used as a reference chromatogram, and peak parameters of peaks (i.e., components) included in the reference chromatogram are used to associate each peak included in the other chromatogram with a peak included in the reference chromatogram.

### SUMMARY OF THE INVENTION

According to the data processing system disclosed in Japanese Patent Laying-Open No. 2023-4872, it can be also said that a corresponding peak in the other chromatogram is identified for each component corresponding to each of the plurality of peaks in the reference chromatogram. In order to automatically identify the plurality of peaks respectively corresponding to the plurality of components, an identification method needs to be set to each component as to how the peaks are specifically associated based on information (hereinafter, referred to as “peak information”) such as a peak area, a peak height, and a peak position of the peak corresponding to each component.

When the identification method is changed, an identification result is also changed, so that it is necessary to set an appropriate identification method in order to obtain an accurate identification result. However, in order to set such an appropriate identification method, trial and error may be required, thus resulting in a burden on the user.

The present disclosure has been made to solve such a problem, and has an object to readily set an identification method to each of a plurality of components.

A setting method according to the present disclosure is executable by a computer to set an identification method to each of a plurality of components. A plurality of target peaks respectively corresponds to the plurality of components and are included in a target chromatogram for an identification target, the plurality of target peaks are identified by determining whether or not each component corresponds to one target peak of the plurality of target peaks, based on a plurality of pieces of peak information respectively corresponding to the plurality of components and in accordance with the identification method set to each of the plurality of components, and the plurality of pieces of peak information are obtained from a reference chromatogram obtained by performing a chromatograph analysis onto a sample including the plurality of components. The setting method for setting an identification method includes: obtaining the plurality of pieces of peak information; determining whether or not one component of the plurality of components is distinguishable from another component other than the one component based on a value of a first peak parameter indicating a feature of a peak included in each of the plurality of pieces of peak information; setting, to a first identification method that is based on the first peak parameter, an identification method for a component that is distinguishable from the other component among the plurality of components based on the first peak parameter; and setting, to another identification method different from the first identification method, an identification method for a component that is not distinguishable from the other component among the plurality of components based on the first peak parameter.

A setting device according to the present disclosure is a setting device for setting an identification method to each of a plurality of components. A plurality of target peaks respectively corresponds to the plurality of components and are included in a target chromatogram for an identification target is identified by determining whether or not each component corresponds to one target peak of the plurality of target peaks, based on a plurality of pieces of peak information respectively corresponding to the plurality of components and in accordance with the identification method set to each of the plurality of components, and the plurality of pieces of peak information are obtained from a reference chromatogram obtained by performing a chromatograph analysis onto a sample including the plurality of components. The setting device for setting an identification method includes: a processor; and a memory that stores a program executable by the processor. The processor is configured to obtain the plurality of pieces of peak information, the processor is configured to determine whether or not one component of the plurality of components is distinguishable from another component other than the one component based on a value of a first peak parameter indicating a feature of a peak included in each of the plurality of pieces of peak information, the processor is configured to set, to a first identification method that is based on the first peak parameter, an identification method for a component that is distinguishable from the other component among the plurality of components based on the first peak parameter, and the processor is configured to set, to another identification method different from the first identification method, an identification method for a component that is not distinguishable from the other component among the plurality of components based on the first peak parameter.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a schematic configuration of a chromatograph system.

FIG. 2 is a flowchart showing a part of a setting process.

FIG. 3 is a flowchart showing a remaining part of the setting process.

FIG. 4 is a diagram showing an exemplary reference chromatogram.

FIG. 5 is a diagram schematically showing an exemplary data structure of setting information.

FIG. 6 is a diagram showing an exemplary setting screen displayed on a display.

FIG. 7 is a flowchart showing a part of an identification process.

FIG. 8 is a flowchart showing a remaining part of the identification process.

FIG. 9 is a diagram showing an exemplary identification result.

### DESCRIPTION OF THE PREFERRED EMBODIMENTS

Hereinafter, an embodiment of the present disclosure will be described in detail with reference to figures. It should be noted that in the figures, the same or corresponding portions are denoted by the same reference characters and will not be described repeatedly.

### [Chromatograph System]

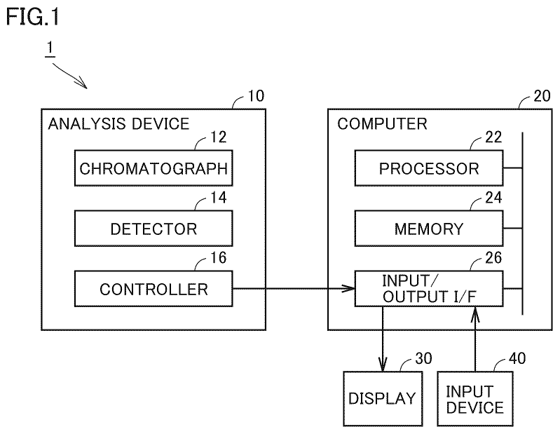

FIG. 1 is a block diagram showing a schematic configuration of a chromatograph system. Chromatograph system 1 includes an analysis device 10, a computer 20, a display 30, and an input device 40. Analysis device 10 is configured to communicate with a computer 20. Computer 20 is configured to obtain an analysis result or the like produced by analysis device 10. Computer 20 notifies, to a user via display 30, information or the like for setting an analytical investigation condition for analytically investigating the obtained analysis result. Computer 20 receives an input of the analytical investigation condition or the like via input device 40, and analytically investigates, in accordance with the received analytical investigation condition, the analysis result sent from analysis device 10.

Analysis device 10 includes a chromatograph 12, a detector 14, and a controller 16. Chromatograph 12 is, for example, a separation device such as a liquid chromatograph or a gas chromatograph. Detector 14 is a device that detects each of components separated by chromatograph 12, and includes, for example, a photodiode array (PDA) detector, an ultraviolet-visible light detector, a fluorescence detector, a differential refractive index detector, an electrical conductivity detector, an electrochemical detector, an evaporative light scattering detector, a mass spectrometer, or the like.

Controller 16 processes a detection result of detector 14 and controls a whole of analysis device 10 including chromatograph 12 and detector 14. Controller 16 produces a chromatogram based on the detection result sent from detector 14, performs peak detection in accordance with the chromatogram, and extracts information (hereinafter, referred to as “peak information”) of each peak observed on the chromatogram. The “peak information” includes values of various peak parameters such as a peak area, a peak height, and a peak position (retention time, wavelength, m/z, and the like). Controller 16 stores, into a storage device, analysis data including the produced chromatogram and the peak information extracted from the chromatogram. It should be noted that the storage device may be a storage device included in controller 16 or a storage device included in an external processing device configured to communicate with controller 16.

The chromatogram produced by controller 16 includes at least one of a two-dimensional chromatogram and a three-dimensional chromatogram. The two-dimensional chromatogram is a chromatogram representing a detection intensity with respect to a retention time axis. The three-dimensional chromatogram is a chromatogram representing a detection intensity with respect to two axes, i.e., a retention time axis and a wavelength axis or an m/z axis. A type of the produced chromatogram is determined depending on a type of detector 14.

Computer 20 is an example of each of a setting device that performs a “setting process” for setting an identification method to each of a plurality of components and a processing device that performs an “identification process” for identifying a peak corresponding to each of the plurality of components in the chromatogram. It should be noted that the processing device and the setting device may be implemented by different devices.

The “identification process” is a process of identifying a peak corresponding to a component in an identification target chromatogram (hereinafter, also referred to as “target chromatogram”) by determining, in accordance with peak information obtained for each component and an identification method set to each component, whether or not the component corresponds to one peak of a plurality of peaks (hereinafter, also referred to as “target peaks”) in the target chromatogram.

Computer 20 includes a processor 22, a memory 24, and an input/output I/F 26. The units in computer 20 are configured to communicate with one another through a bus.

Processor 22 is typically an arithmetic processing unit such as a central processing unit (CPU) or a micro processing unit (MPU). Processor 22 controls an operation of computer 20 by reading and executing a program stored in memory 24. The program is executed by processor 22 to cause computer 20 to perform: the identification process to associate component peaks appearing in the plurality of chromatograms with each other; and the setting process to set an identification method in the identification process.

Memory 24 is implemented by a storage device such as a ROM (Read Only Memory), a RAM (Random Access Memory), and an HDD (Hard Disk Drive), for example. The ROM stores a program to be executed by processor 22. The RAM temporarily stores data to be used by processor 22 during the execution of the program, and functions as a temporary data memory to be used as a work area. The HDD is a nonvolatile storage device. A semiconductor memory device such as a flash memory may be employed in addition to or instead of the HDD. It should be noted that the program and/or the data may be stored in an external storage device accessible by processor 22.

Input/output I/F 26 is an interface for exchanging various data between processor 22 and an external device connected to input/output I/F 26. The external device includes display 30, input device 40, and analysis device 10. For example, computer 20 obtains, via input/output I/F 26, data of a chromatogram produced by controller 16, data regarding an analysis condition for the chromatogram, data indicating a type of detector 14, and the like.

Display 30 is an exemplary notification unit that notifies predefined information to the user. As an example, display 30 displays the chromatogram produced by controller 16, a processing result of the identification process, a setting screen for setting an association condition in the identification process, a setting content that is a result of the setting process, or the like.

Input device 40 is typically constituted of a touch panel, a keyboard, a mouse, and the like. Input device 40 receives a user's input operation for processor 22. As an example, input device 40 is used to input an association condition.

In order to find an analysis condition suitable for a sample, the user may perform an analysis on the same sample with the analysis condition being changed. For example, the user performs an analysis with a type of mobile phase, a type of stationary phase, a flow rate of the mobile phase, a condition of a gradient analysis, and the like being changed. Since the identification process is performed onto each of a plurality of chromatograms obtained with the analysis condition being changed, peaks appearing in the plurality of chromatograms can be associated with each other and the user can relatively evaluate each peak, thereby finding the analysis condition.

Computer 20 is configured to obtain a plurality of pieces of analysis data obtained by analyzing the same sample under a plurality of different analysis conditions. The plurality of pieces of analysis data obtained by analyzing the same sample under the plurality of different analysis conditions are stored in a storage device as a group of data sets. The storage device may be memory 24 included in computer 20 or may be a storage device included in an external processing device (for example, controller 16) configured to communicate with computer 20.

### [Setting Process]

Computer 20 performs the identification process for identifying a peak corresponding to a component and the setting process for setting an identification method for each component. In the present embodiment, the “identification process” refers to a process automatically performed by computer 20 in accordance with the identification method set in the setting process. The “setting process” refers to a process of automatically setting, by computer 20, the identification method for each component in accordance with a predefined condition.

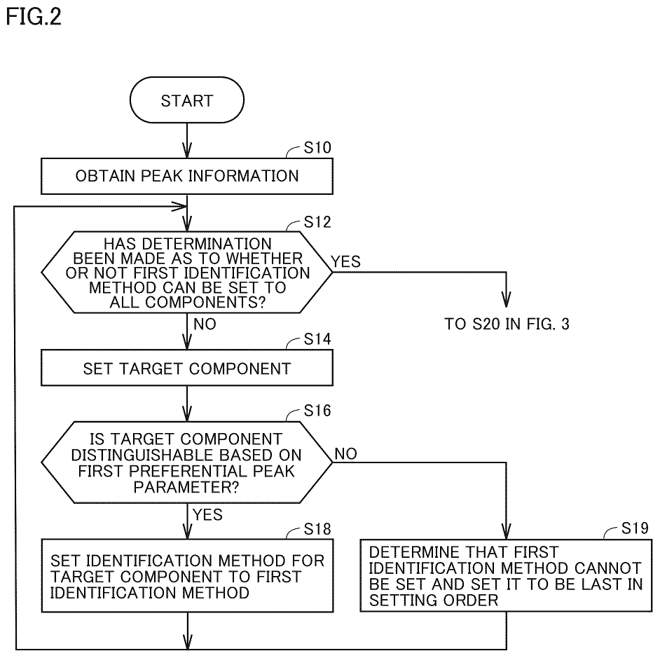

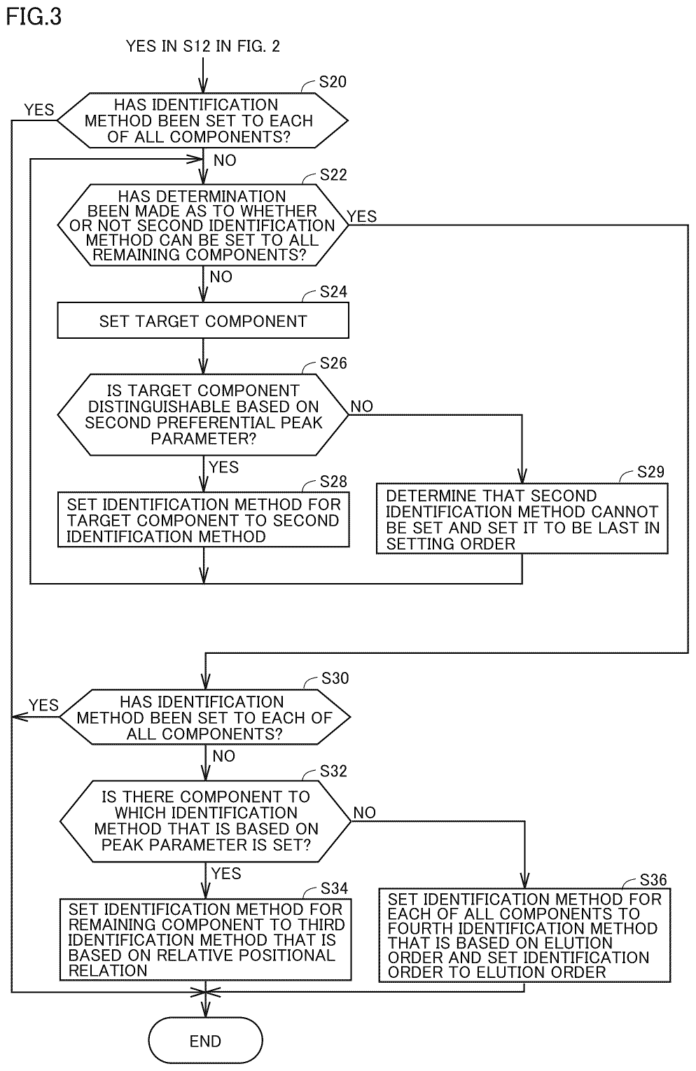

FIG. 2 is a flowchart showing a part of the setting process. FIG. 3 is a flowchart showing a remaining part of the setting process. Processing steps (hereinafter, abbreviated as “S”) shown in FIGS. 2 and 3 are implemented by processor 22 executing a program stored in memory 24. As an example, the setting process is performed when an operation to start automatic setting of the identification process condition is received via input device 40.

For example, in the case of performing the identification process onto each of the plurality of chromatograms obtained for the same sample under the analysis condition being changed, the user operates input device 40 to perform the setting process before performing the identification process.

In S10, computer 20 obtains a plurality of pieces of peak information respectively corresponding to a plurality of components included in an analysis target sample. In the present embodiment, computer 20 selects one piece of analysis data from the chromatograms, which are the plurality of pieces of analysis data stored in the storage device as the group of data sets, and obtains a plurality of pieces of peak information from the selected analysis data. The one piece of analysis data may be selected by the user or may be selected by computer 20 in accordance with a predefined condition. Each of the obtained pieces of peak information includes values of various peak parameters such as a peak area, a peak height, and a peak position (retention time (for example, a peak number given in the order from an earlier elution time), wavelength, m/z, and the like). It should be noted that in the description below, the chromatogram from which the pieces of peak information obtained in S10 are extracted may be referred to as a “reference chromatogram”.

It should be noted that the plurality of pieces of peak information may be extracted from one chromatogram obtained by actually performing a chromatograph analysis onto a standard sample produced by simulating an analysis target sample, instead of the analysis target sample. For example, when it is estimated that a component 1 and a component 2 are included in the analysis target sample, the “standard sample” is produced by mixing components 1 and 2. Further, the plurality of pieces of peak information are not limited to being extracted from the chromatogram produced by analysis device 10, and may be extracted from a chromatogram produced by an analysis device different from analysis device 10. The analysis device different from analysis device 10 is preferably a device having a configuration similar to that of analysis device 10 (for example, a configuration common in terms of the type of stationary phase, the type of detector, and the like).

In S12, computer 20 determines whether or not a determination has been made as to whether or not one predefined identification method (hereinafter, referred to as a “first identification method”) can be set to all the components. When it is determined that the determination has been made (YES in S12), computer 20 proceeds the process to S20 shown in FIG. 3. When it is determined that the determination has not been made (NO in S12), computer 20 proceeds the process to S14.

The first identification method, which will be described later, is an identification method that is based on one predefined peak parameter (hereinafter, also referred to as “first preferential peak parameter”) of one or a plurality of parameters (hereinafter, also referred to as “peak parameters”) each representing a feature of a peak.

In S14, computer 20 selects one component for which no determination has been made, and sets the selected one component as a target component. For example, computer 20 selects the target component in accordance with the order of peak numbers.

In S16, computer 20 determines whether or not the target component is distinguishable from another component based on the first preferential peak parameter.

The first preferential peak parameter is a peak parameter that can be appropriately selected by a business entity, which provides chromatograph system 1, the user, or the like from the one or plurality of peak parameters that can be extracted from the peak, and that is considered to represent the feature of the peak the most.

The peak parameter is, for example, m/z of a base peak, a spectrum (mass spectrum, PDA spectrum, or the like), a peak area ratio, a peak height ratio, or the like. The m/z of the base peak is a peak parameter that can be extracted when detector 14 is a mass spectrometer, and means the m/z of a mass peak having the largest detection intensity among respective mass spectra obtained for elution times. The peak area ratio means a ratio of a peak area of the target peak to a total area of all the peaks appearing on the same chromatogram. The peak height ratio means a ratio of a peak height of a peak of the target component to a total height of all the component peaks appearing on the same chromatogram.

As an example, whether or not the target component is distinguishable from another component based on the peak parameter is determined as follows. For example, when determining whether or not the target component is distinguishable based on the m/z of the base peak, the peak area ratio, or the peak height ratio, computer 20 compares a value of the peak parameter of the target component peak with a value of a peak parameter of a peak of another component other than the target component. Computer 20 determines whether or not there is a component peak for which a difference from the value of the peak parameter of the target component peak is less than a predefined threshold value (hereinafter, also referred to as a “first threshold value”), determines that the target component is not distinguishable when there is such a component peak, and determines that the target component is distinguishable when there is not such a component peak. The first threshold value is appropriately set by the business entity, which provides chromatograph system 1, or the user in accordance with a resolution of detector 14 or the like.

Further, when it is determined whether or not the target component is distinguishable based on a spectrum (for example, a PDA spectrum or a mass spectrum), computer 20 compares a spectrum corresponding to the target component peak with a spectrum corresponding to a peak of another component other than the target component. Computer 20 determines whether or not there is a spectrum for which a degree of similarity to the spectrum corresponding to the target component is more than a predefined threshold value (hereinafter, also referred to as a “second threshold value”), determines that the target component is not distinguishable when there is such a spectrum, and determines that the target component is distinguishable when there is not such a spectrum. The second threshold value is appropriately set by the business entity, which provides chromatograph system 1, or the user in accordance with the resolution of detector 14 or the like.

When it is determined that the target component is distinguishable (YES in S16), computer 20 sets an identification method for the target component to the first identification method that is based on the first preferential peak parameter in S18, and proceeds the process to S12.

When the identification process is performed based on the peak parameter, the identification is performed as follows. As an example, when the m/z of the base peak is set as the peak parameter, computer 20 sets, as an identification condition for one component, the m/z of the base peak of the target component peak and a predefined threshold value (hereinafter, also referred to as a “third threshold value”). In the identification process, computer 20 searches a target chromatogram for a target peak having an m/z within a range of the set m/z±the third threshold value, and identifies the target peak as the target peak corresponding to the one component. It should be noted that the first threshold value set to determine whether or not a component in the reference chromatogram is distinguishable may be the same as or different in value from the third threshold value set to identify a corresponding component from the target chromatogram. Alternatively, the target component peak most similar to the m/z of the base peak may be simply identified as the target peak corresponding to the one component.

Further, as an example, when the spectrum is set as a peak parameter for the one component, computer 20 sets, as an identification condition for the one component, a spectrum corresponding to the peak of the one component and a threshold value (hereinafter, also referred to as a “fourth threshold value”) for a degree of similarity to the spectrum. In the identification process, computer 20 searches a target chromatogram for a target peak having a spectrum for which a degree of similarity to the spectrum corresponding to the peak of the one component is equal to or more than the fourth threshold value, and identifies the target peak as the target peak corresponding to the one component. It should be noted that the second threshold value set to determine whether or not a component in the reference chromatogram is distinguishable may be the same as or different in value from the fourth threshold value set to identify a corresponding component from the target chromatogram. Alternatively, the target component peak most similar to the spectrum of the base peak may be simply identified as the target peak corresponding to the one component.

On the other hand, when it is determined that the target component is not distinguishable (NO in S16), computer 20 determines in S19 that the first identification method cannot be set to the target component, sets the target component to be the last in a setting order, and proceeds the process to S12. It should be noted that the setting order is an order of setting an identification method in the setting process, and specifically, refers to an order of selecting an identification method for a target component in each of S14 and S24. Further, in the present embodiment, computer 20 sets an identification order (order of identifying a component) in the identification process such that the identification method is set in the setting order.

Computer 20 repeats the processes of S14 to S19 until a determination is ended as to whether or not all the components can be identified by the first identification method, and proceeds the process to S20 shown in FIG. 3 when the determination is ended (YES in S12).

In S20, computer 20 determines whether or not the identification method is set to each of all the components. When it is determined that the identification method is set thereto (YES in S20), computer 20 ends the setting process. A fact that it is determined in S20 that the identification method is set to each of all the components means that the first identification method is set to all the components. Further, when the processes of S14 to S19 are performed in accordance with the peak numbers (elution order), the identification order is the same as the elution order.

When it is determined that the identification method is not set thereto (NO in S20), computer 20 proceeds the process to S22. A fact that an identification method for at least one component is not set in S20 means that it is determined that the at least one component is not distinguishable from another component based on the first preferential peak parameter.

In S22, computer 20 determines whether or not a determination has been made as to whether or not one predefined identification method (hereinafter, referred to as a “second identification method”) different from the first identification method can be set to all the remaining components to each of which no identification method is set. When it is determined that the determination has been made (YES in S22), computer 20 proceeds the process to S30. When it is determined that the determination has not been made (NO in S22), computer 20 proceeds the process to S24. The second identification method is an identification method that is based on one predefined peak parameter (hereinafter, also referred to as a “second preferential peak parameter”) different from the first preferential peak parameter of the peak parameters.

In S24, one component for which the determination has not been made is selected from the remaining components to each of which no identification method is set, and the selected one component is set as a target component. In S24, computer 20 sets, as a target component, one component for which no determination has been made as to whether or not the component can be identified by the second identification method, among the components determined to be indistinguishable from another component based on the first preferential peak parameter. It should be noted that when the processes of S14 to S19 are performed in accordance with the peak numbers (elution order), in S24, the target component is selected, in accordance with the order of the peak numbers, from the remaining components to each of which no identification method is set.

In S26, computer 20 determines whether or not the target component is distinguishable from another component based on the second preferential peak parameter. Here, the other component in S26 is a component other than the component to which the identification method is set and the target component set in S24 among the plurality of components respectively corresponding to the plurality of pieces of peak information obtained in S10. In other words, the other component in S26 is a component other than the target component set in S24 among the components to each of which no identification method is set.

When it is determined that the target component is distinguishable (YES in S26), computer 20 proceeds the process to S28. On the other hand, when it is determined that the target component is not distinguishable (NO in S26), computer 20 proceeds the process to S29. It should be noted that a method of determining whether or not the target component is distinguishable from another component based on the peak parameter is the same as that in S16, and therefore will not be described repeatedly.

The second preferential peak parameter can be appropriately selected by the business entity, which provides chromatograph system 1, or the user from the one or plurality of peak parameters that can be extracted from the component peak, and a peak parameter considered to represent the feature of the component peak the most after the first preferential peak parameter is selected.

As an example, when detector 14 is a PDA detector, the spectrum is selected as the first preferential peak parameter, and the peak area ratio or peak height ratio is selected as the second preferential peak parameter.

It should be noted that when the second preferential peak parameter is not selected, computer 20 may determine that the target component is not distinguishable from another component based on the second preferential peak parameter, and may proceed the process to S29. For example, when detector 14 is a mass spectrometer, the m/z of the base peak may be selected as the first peak parameter and the second peak parameter may not be selected.

When it is determined that the target component is distinguishable (YES in S26), computer 20 sets the identification method for the target component to the second identification method that is based on the second preferential peak parameter in S28, and proceeds the process to S22. It should be noted that the identification method that is based on the peak parameter is the same as that in S18, and therefore will not be described repeatedly.

On the other hand, when it is determined that the target component is not distinguishable (NO in S26), computer 20 determines in S29 that the second identification method cannot be set to the target component, sets the target component to be the last in the setting order, and proceeds the process to S22.

Computer 20 repeats the processes of S24 to S29 until a determination is ended as to whether or not the second identification method can be set to all the components determined to be indistinguishable from another component based on the first preferential peak parameter, and proceeds the process to S30 when the determination is ended (YES in S22).

Computer 20 repeats the processes of S24 to S29 until the determination is ended as to whether or not all the remaining components to each of which the first identification method is not set can be identified by the second identification method, and proceeds the process to S30 when the determination is ended (YES in S22).

In S30, computer 20 determines whether or not the identification method is set to each of all the components. When it is determined that the identification method is set thereto (YES in S30), computer 20 ends the setting process. A fact that the identification method is set to each of all the components in S30 means that the first identification method or the second identification method is set to each of all the components. Further, the component determined to be unable to be identified by the first identification method in S19 is set to be the last in the setting order, and computer 20 sets the identification order so as to correspond to the order of setting the identification method. Therefore, the identification order is set to correspond to the order of the component to which the first identification method is set and the component to which the second identification method is set. In the case where the processes of S14 to S19 are performed in accordance with the peak numbers (elution order), when there are a plurality of components to each of which the first identification method is set, the identification order of the plurality of components corresponds to the elution order (peak numbers). Similarly, when there are a plurality of components to each of which the second identification method is set, the identification order of the plurality of components corresponds to the elution order (peak numbers).

When it is determined that the identification method is not set to each of all the components (NO in S30), computer 20 proceeds the process to S32. A fact that an identification method for at least one component is not set in S30 means that it is determined that the at least one component is not distinguishable from another component based on either of the first preferential peak parameter and the second preferential peak parameter.

In S32, computer 20 determines whether or not there is a component to which the identification method that is based on the peak parameter is set. When it is determined that an identification method set to at least one component is the identification method that is based on the peak parameter (YES in S32), computer 20 proceeds the process to S34.

In S34, computer 20 determines an identification method for each remaining component to an identification method that is based on a relative positional relation (hereinafter, also referred to as a “third identification method”), and ends the setting process. The third identification method will be described later with reference to figures. It should be noted that the component determined to be unable to be identified by the second identification method in S29 is set to be the last in the setting order, and computer 20 sets the identification order so as to correspond to the order of setting the identification method. Therefore, the identification order is set to correspond to the order of the component to which the first identification method is set, the component to which the second identification method is set, and the component to each of which the third identification method is set. It should be noted that when there are a plurality of remaining components to each of which the identification method is not set in S34, computer 20 may set the identification order of the remaining components to correspond to the elution order (peak numbers).

When it is determined that there is no component for which the identification method that is based on the peak parameter is set (NO in S32), i.e., when it is determined that no component is distinguishable from another component based on the selected peak parameter (first preferential peak parameter or second preferential peak parameter), computer 20 proceeds the process to S36.

In S36, computer 20 sets the identification method for each of all the components to an identification method that is based on the elution order (peak number), sets the identification order to correspond to the elution order (peak numbers), and ends the setting process.

As described above, computer 20 sets the identification method for each of the plurality of components based on the respective pieces of peak information of the components and in accordance with the predefined condition. Therefore, an appropriate identification method can be set in accordance with the feature of the peak corresponding to each component in the chromatogram obtained by analyzing the analysis target sample without requiring trial and error by the user. As a result, the identification method can be readily set to each of the plurality of components.

Further, in the present embodiment, computer 20 sets the identification order so as to correspond to the order of setting an identification method. Computer 20 determines whether or not the first identification method can be set to all the components, sets, to the first identification method, an identification method for a component to which the first identification method can be set, then determines whether or not the second identification method can be set to all the components to each of which the first identification method is determined to be unable to be set, and sets, to the second identification method, an identification method for a component to which the second identification method can be set. Then, computer 20 sets, to the third identification method, an identification method for each of all the components to each of which either of the first identification method and the second identification method is determined to be unable to be set. Therefore, the identification order corresponds to the order of the component to which the first identification method is set, the component to which the second identification method is set, and the component to which the third identification method is set.

It should be noted that the setting process shown in FIGS. 2 and 3 is an example, and computer 20 may set the identification method to each of all the components by sequentially setting the identification methods to the plurality of components, and then may set the identification order so as to correspond to the order of the peak of the component to which the first identification method is set, the peak of the component to which the second identification method is set, and the peak of the component to which the third identification method is set.

It should be noted that in FIGS. 2 and 3, computer 20 sets, to a component that is not distinguishable from another component by using either of the two types of peak parameters, the third identification method that is based on the relative positional relation. It should be noted that computer 20 may set the third identification method to a component that is not distinguishable from another component by using one peak parameter. That is, when it is determined that the determination has been made as to whether or not the first identification method can be set (YES in S12), computer 20 may proceed the process to S30 without performing S20 to S29.

Further, computer 20 may set the third identification method to a component that is not distinguishable from another component by using any of three or more types of peak parameters. In this case, when it is determined that the determination has been made as to whether or not the second identification method can be set (YES in S22), computer 20 may determine whether or not an identification method that is based on a third preferential peak parameter (peak parameter considered to represent the feature of the peak the most after the first preferential peak parameter and the second preferential peak parameter) can be set to a remaining component to which no identification method is set. A determination method is the same as that in each of S12 to S19 and S22 to S29, and therefore will not be described repeatedly. After making the determination for each of all the peak parameters, computer 20 may proceed the process to S30 so as to set, to the third identification method that is based on the relative positional relation or a fourth identification method that is based on the elution order, an identification method for a remaining component to which no identification method is set. Thus, by increasing the number of types of identification methods that can be set, it is possible to set an identification method more appropriate for each component.

### [Setting Information and Setting Screen]

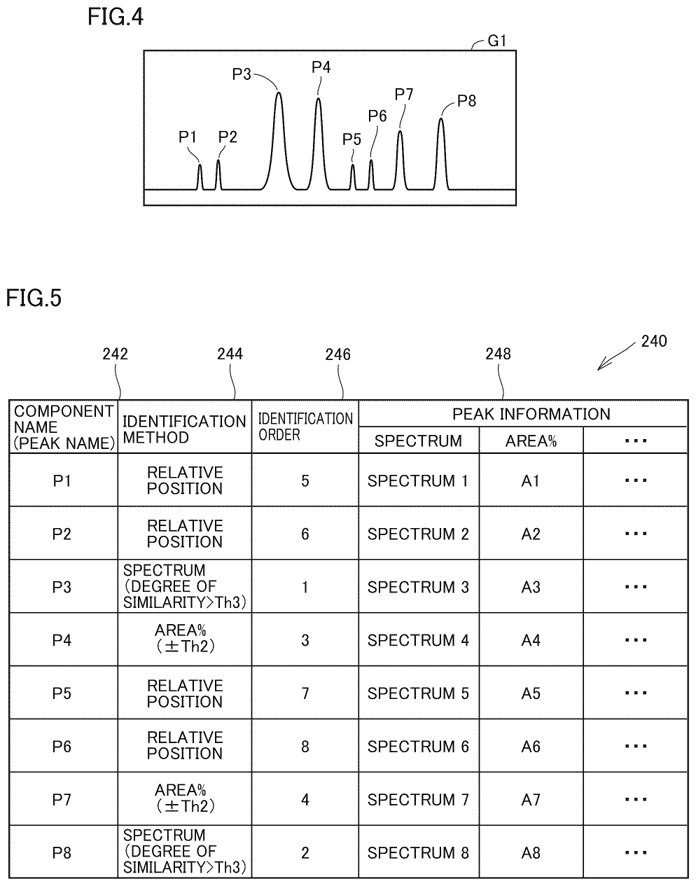

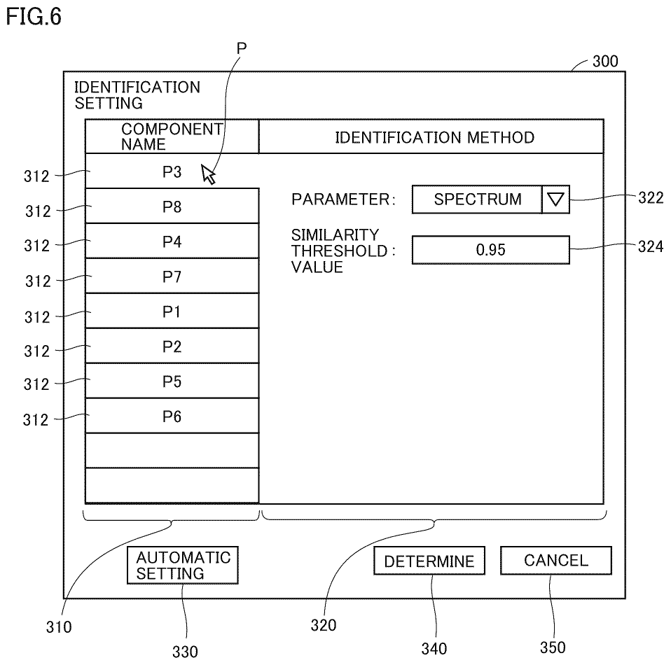

FIG. 4 is a diagram showing an exemplary reference chromatogram. FIG. 5 is a diagram schematically showing an exemplary data structure of setting information. FIG. 6 is a diagram showing an exemplary setting screen displayed on the display. It is assumed that setting information 240 shown in FIG. 5 is obtained when the setting process is performed based on peak information 248 extracted from a reference chromatogram G1 shown in FIG. 4. It is assumed that a setting screen 300 shown in FIG. 6 is produced in accordance with setting information 240 shown in FIG. 4. It should be noted that reference chromatogram G1 shown in FIG. 4 illustratively represents a two-dimensional chromatogram indicating a detection intensity with respect to a retention time axis; however, it is assumed that a spectrum (for example, a PDA spectrum) is obtained for each peak.

When eight peaks (P1 to P8) appear in reference chromatogram G1 as shown in FIG. 4, peak information 248 is obtained for each of the eight components (peaks P1 to P8), and an identification method 244 and an identification order 246 are set to each of the eight components (peaks P1 to P8) as shown in FIG. 5. It should be noted that a component name 242 may be set by the user or computer 20 separately from a peak name (for example, a peak number).

Referring to FIG. 6, setting screen 300 includes: an region 310 in which a component name (for example, a peak number) is displayed; an region 320 in which an identification method set to a component selected in region 310 is displayed; a button 330 for starting the setting process shown in FIGS. 2 and 3; a determination button 340; and a cancel button 350.

When a pointer P is moved via input device 40 so as to select button 330, computer 20 obtains peak information 248 of each component (each peak) extracted from the reference chromatogram shown in FIG. 4, and starts the setting process shown in FIGS. 2 and 3 based on the obtained peak information 248. Computer 20 sets identification method 244 and identification order 246 for each component by performing the setting process. When the setting process is completed, setting screen 300 is updated in accordance with identification method 244 and identification order 246 set by the setting process.

In region 310, the names of the components of the peaks extracted from the reference chromatogram are displayed in accordance with the identification order. For example, in the example shown in FIGS. 5 and 6, the identification order is set to be the order of P3, P8, P4, P7, P1, P2, P5, and P6.

It should be noted that the identification order can be changed in such a manner that button 312 on which the component name is displayed is moved by pointer P via input device 40 with button 312 being selected. When determination button 340 is selected after the identification order is changed, the changed identification order is determined. That is, computer 20 can perform a step of receiving an input of the identification order and a step of determining the identification order so as to correspond to the input of order. That is, the identification order can be freely set by the user.

In region 320, the identification method set to the component selected in region 310 is displayed. Region 320 displays: a set peak parameter; and a threshold value for determining whether or not a component can be associated in accordance with the peak parameter. It should be noted that when a pull-down button 322 displayed in region 320 is selected, a peak parameter that can be set is displayed and the user can change the peak parameter to be set. Further, the user can input, via input device 40, any threshold value into a text box 324 displayed in region 320. That is, an association condition in the identification process can be automatically set by the identification process, or can be freely set for each component peak by the user.

### [Identification Process]

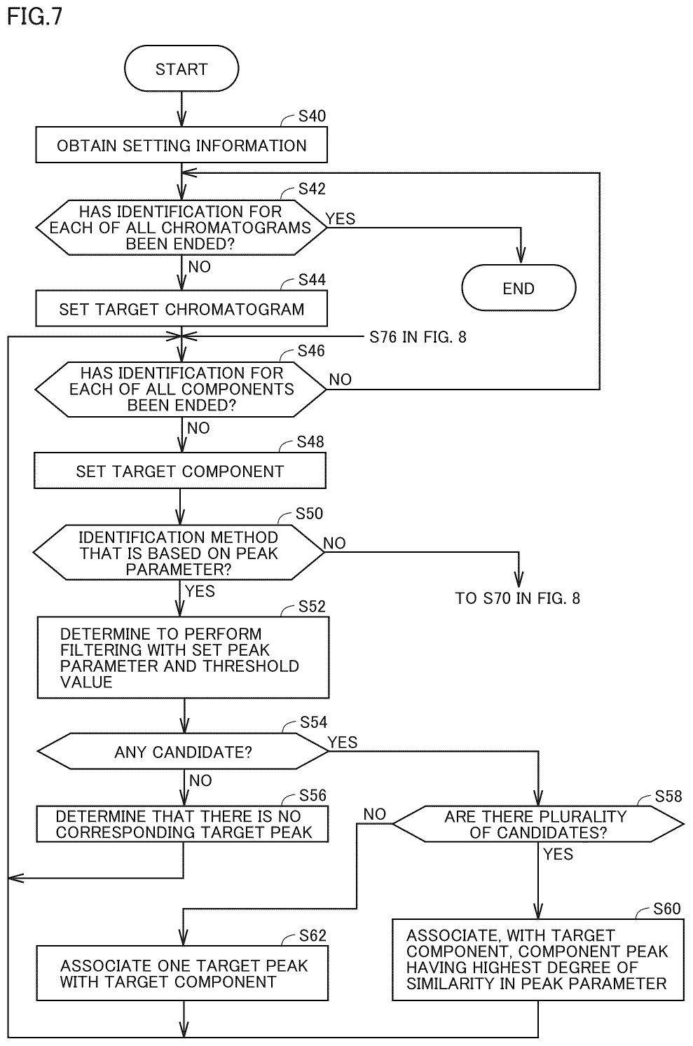

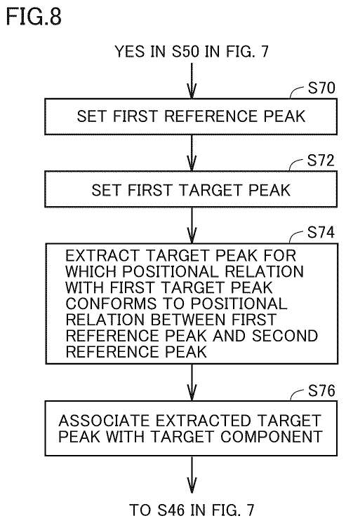

FIG. 7 is a flowchart showing a part of the identification process. FIG. 8 is a flowchart showing a remaining part of the identification process. Processing steps shown in FIGS. 7 and 8 are implemented by processor 22 executing a program stored in memory 24. The identification process is performed when a group of data sets to be subjected to the identification process is selected via input device 40 and an operation of starting automatic identification is received. It should be noted that as described above, the group of data sets includes a plurality of pieces of analysis data obtained by analyzing the same sample under a plurality of different analysis conditions.

In 540, computer 20 obtains setting information 240. Setting information 240 is information produced by the setting process described above, and an identification method 244 and an identification order 246 are set to each component. Setting information 240 is stored for each group of data sets. Computer 20 obtains setting information 240 by reading, from memory 24, setting information 240 corresponding to the selected data sets.

In S42, computer 20 determines whether or not the identification for all the chromatograms is ended. When it is determined that the identification for all the chromatograms is ended (YES in S42), computer 20 ends the identification process. When it is determined that the identification for all the chromatograms is not ended (NO in S42), computer 20 proceeds the process to S44.

In S44, computer 20 selects one chromatogram that has not been through the identification process from the chromatograms in the selected data sets, and sets the selected chromatogram as a target chromatogram for the identification. It should be noted that the order of setting a chromatogram as the target chromatogram may be any order. For example, when the respective chromatograms are given ID numbers, computer 20 may set the target chromatogram in the order from the smallest one of the ID numbers.

In S46, computer 20 determines whether or not the identification for all the components is ended. When it is determined that the identification is ended (YES in S46), computer 20 proceeds the process to S42 on the assumption that the identification for the set target chromatogram is completed, whereas when there is a chromatogram for which the identification is not ended (NO in S42), computer 20 newly sets a target chromatogram in S44. When it is determined that the identification is not ended (NO in S46), computer 20 proceeds the process to S48.

In S48, computer 20 selects one component for which the identification process is not ended, and sets the selected component as a target component. The order of setting as a target component conforms to the identification order set by the setting process or the user operation.

In S50, computer 20 determines whether or not the identification method for the target component is an identification method that is based on a peak parameter. When it is determined that the identification method for the target component is an identification method that is based on a peak parameter (YES in S50), computer 20 proceeds the process to S52. When it is determined that the identification method for the target component is not an identification method that is based on a peak parameter (NO in S50), i.e., when it is determined that the identification method for the target component is the third identification method that is based on the relative positional relation, computer 20 proceeds the process to S70 shown in FIG. 8.

In S52, computer 20 performs filtering of the target peak on the target chromatogram in accordance with the peak parameter set to the target component as well as a threshold value. For example, when the “spectrum” is set as the peak parameter, computer 20 searches the target chromatogram for a target peak having a spectrum for which a degree of similarity to the spectrum of the target component is equal to or more than a predefined fourth threshold value (for example, 0.90).

In S54, computer 20 determines whether or not there is a candidate for the target peak corresponding to the target component. For example, when a spectrum for which a degree of similarity to the spectrum of the reference component is equal to or more than a predefined similarity threshold value (for example, 0.90) exists in the target chromatogram, computer 20 determines that there is a candidate for the target peak corresponding to the target component (YES in S54), and proceeds the process to S58. When the above-described spectrum does not exist in the target chromatogram, computer 20 determines that there is no candidate for the target peak corresponding to the target component (NO in S54), and proceeds the process to S56.

In S56, computer 20 determines that there is no target peak corresponding to the target component in the target chromatogram, ends the identification for the target component, and proceeds the process to S46.

In S58, computer 20 determines whether or not there are a plurality of candidates. For example, when a plurality of spectra for each of which a degree of similarity to the spectrum of the target component is equal to or more than the predefined similarity threshold value (for example, 0.90) exist in the target chromatogram, computer 20 determines that there are a plurality of candidates (YES in S58), and proceeds the process to S60. When only one spectrum for which the degree of similarity thereto is equal to or more than the similarity threshold value exists in the target chromatogram, computer 20 determines that there are not a plurality of candidates (NO in S58), and proceeds the process to S62.

In S60, computer 20 associates, with the target component, a target peak for which the degree of similarity in the peak parameter is the highest among the plurality of candidates, ends the identification for the target component, and proceeds the process to S46. For example, computer 20 associates, with the target component, the target peak corresponding to the spectrum for which the degree of similarity is the highest. On the other hand, in the identification method that is based on the peak parameter, the identification may be performed by associating, with the target component, the target peak for which the degree of similarity in peak parameter is the highest without performing the filtering using the threshold value.

In S62, computer 20 associates one target peak existing as a candidate with the target component, ends the identification for the target component, and proceeds the process to S46. For example, computer 20 associates, with the target component, a target peak corresponding to one spectrum for which a degree of similarity thereto is equal to or more than the similarity threshold value.

It should be noted that when it is determined in the setting process to perform the association based on the peak number (S36 of FIG. 3), the peak number is set as the peak parameter and computer 20 therefore performs the processes of S52 to S62.

When it is determined that the identification method is not the identification method that is based on each peak parameter (NO in S50), i.e., when it is determined that the identification method is the third identification method that is based on the relative positional relation, computer 20 proceeds the process to S70 shown in FIG. 8.

In S70, computer 20 extracts, from the reference chromatogram, the peak of the identified component for which the retention time is the closest to that of the target component peak in the reference chromatogram, and sets the extracted peak in the reference chromatogram as the first reference peak. It should be noted that the target component peak in the reference chromatogram is also referred to as a “second reference peak”. As described with reference to FIGS. 2 and 3, the component to which the third identification method is set is set to come, in the identification order, after the component to which the first identification method or the second identification method each for identifying based on a peak parameter is set. Therefore, the identification for the component to which the first identification method or the second identification method is set is completed before the identification for the component to which the third identification method is set.

In 572, computer 20 sets, as the first target peak, the target peak in the target chromatogram associated with the component of the first reference peak.

In 574, computer 20 extracts, from the target chromatogram, a target peak for which a positional relation with the first target peak conforms to the positional relation between the first reference peak and the second reference peak. The positional relation conforming to the positional relation between the first reference peak and the second reference peak is, for example, a positional relation conforming to the elution order (peak numbers). For example, computer 20 extracts, from the target chromatogram, the target peak of the peak number obtained by subtracting, from the peak number of the first target peak, a difference obtained by subtracting the peak number of the second reference peak from the peak number of the first target peak.

In S76, computer 20 associates the extracted target peak with the target component, ends the identification for the target component, and proceeds the process to S46. Specifically, when the second reference peak (the target component peak in the reference chromatogram) is located next to the first reference peak (the peak of the identified component in the reference chromatogram) in the reference chromatogram, the target peak next to the first target peak (the target peak associated with the first reference peak) in the target chromatogram is associated with the target component.

As described above, after identifying the target peak corresponding to the component that can be identified based on the peak parameter, computer 20 associates, based on the relative positional relation, the component that cannot be identified based on the peak parameter with the target peak.

Therefore, since the component that cannot be identified based on the peak parameter can be associated in consideration of the relation with the other component, the identification process can be proceeded with higher accuracy than in the case where the component is simply identified in accordance with the peak number.

It should be noted that in the example shown in FIG. 8, the first reference peak is set in the identification process. It should be noted that computer 20 may set the first reference peak in the setting process and may store the set first reference peak in the memory 24 in association with the component to which the third identification method is set.

As described with reference to FIGS. 2 and 3, since the first preferential peak parameter is a peak parameter that is considered to represent the feature of the peak of the component more than the second preferential peak parameter, the first identification method is considered to have higher identification accuracy than the second identification method. Further, the third identification method is not an identification method using a peak parameter representing a peak of each component, and is an identification method that is based on a positional relation with a peak of another identified component. Therefore, the identification accuracy of each of the identification methods using the peak parameters that are each based on the feature of the component is considered to be higher than that of the third identification method.

As described with reference to FIGS. 2 and 3, for each component peak, computer 20 reviews whether or not the identification method can be used in the order from the identification method allowing for the highest identification accuracy. Therefore, the identification can be performed for each component peak with high accuracy.

As described with reference to FIGS. 2 and 3, computer 20 sets the identification order in the order of the component to which the first identification method is set, the component to which the second identification method is set, and the component to which the third identification method is set. Therefore, when associating a component to which the second identification method is set, the association of the component to which the first identification method is set has been ended, thereby narrowing down a candidate for the target peak to be associated with the component to which the second identification method is set. Thus, the identification process can be proceeded with higher accuracy. That is, in the present embodiment, computer 20 can set an appropriate identification order in accordance with the identification method set to each component.

### [Identification Result]

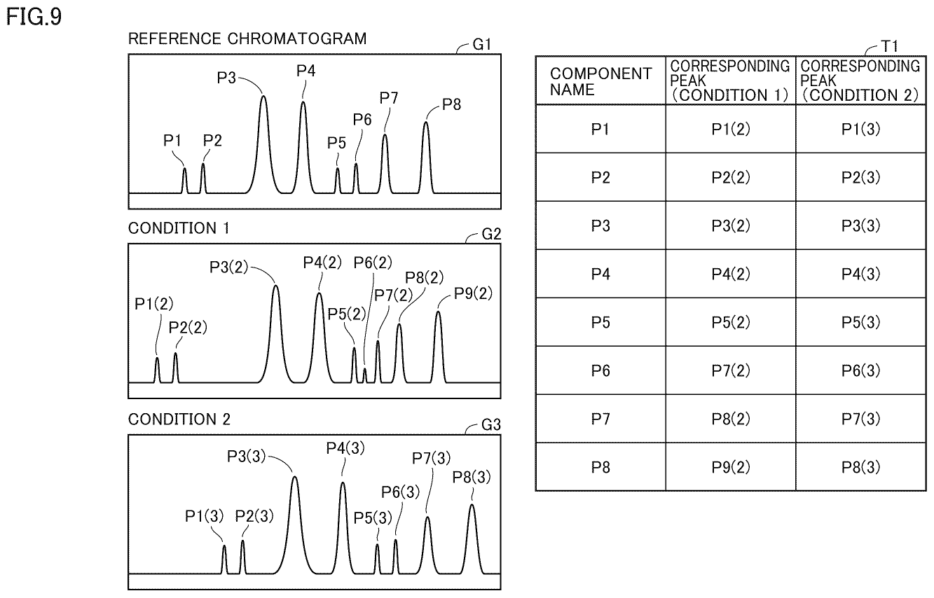

FIG. 9 is a diagram showing an exemplary identification result. As an example, reference chromatogram G1, identification target chromatograms G2, G3, and a list T1 of peaks of target chromatograms associated with respective components are displayed on display 30. It should be noted that each of reference chromatogram G1 and identification target chromatograms G2, G3 as shown in FIG. 9 illustratively represents a two-dimensional chromatograms indicating a detection intensity with respect to a retention time axis; however, it is assumed that a spectrum (for example, a PDA spectrum) is obtained for each peak. Reference chromatogram G1 shown in FIG. 9 is the same as reference chromatogram G1 shown in FIG. 4, and explanation will be made on such an assumption that the identification result shown in FIG. 9 is obtained by performing the identification process in accordance with setting information 240 shown in FIG. 5. It should be noted that in the example shown in FIG. 9, reference chromatogram G1 is displayed for ease of explanation, but reference chromatogram G1 may not be displayed.

For example, according to chromatogram G2 obtained under a condition 2, the number of extracted component peaks is larger by one than that in each of reference chromatogram G1 and chromatogram G3. In this case, when the association in accordance with the elution order is performed, a peak P7(2) in chromatogram G2 is associated with a component P7. However, as understood from a comparison between reference chromatogram G1 and chromatogram G2, it may be more appropriate to associate a peak P8(2) with component P7 in view of the peak area ratio, the relative positional relation with the other peak, or the like.

In such a case, the identification accuracy can be further improved by making setting to first identify a component that can be identified based on a peak parameter and then associate a peak in accordance with a relative positional relation with the identified component.

### [Aspects]

It is understood by one having ordinary skill in the art that the embodiments described above are specific examples of the following aspects.

(Item 1) A setting method according to one aspect is executable by a computer to set an identification method to each of a plurality of components. A plurality of target peaks respectively corresponds to the plurality of components and are included in a target chromatogram for an identification target, the plurality of target peaks are identified by determining whether or not each component corresponds to one target peak of the plurality of target peaks, based on a plurality of pieces of peak information respectively corresponding to the plurality of components and in accordance with the identification method set to each of the plurality of components, and the plurality of pieces of peak information are obtained from a reference chromatogram obtained by performing a chromatograph analysis onto a sample including the plurality of components. The setting method includes: obtaining the plurality of pieces of peak information; determining whether or not one component of the plurality of components is distinguishable from another component other than the one component based on a value of a first peak parameter indicating a feature of a peak included in each of the plurality of pieces of peak information; setting, to a first identification method that is based on the first peak parameter, an identification method for a component that is distinguishable from the other component among the plurality of components based on the first peak parameter; and setting, to another identification method different from the first identification method, an identification method for a component that is not distinguishable from the other component among the plurality of components based on the first peak parameter.

With the setting method according to item 1, the computer sets the identification method for each of the plurality of components based on the peak information of the component and in accordance with the predefined condition. Therefore, an appropriate identification method can be set in accordance with the feature of the peak corresponding to each component in the reference chromatogram without requiring trial and error by the user. As a result, the identification method can be readily set to each of the plurality of components.

(Item 2) In the setting method according to item 1, the determining whether or not the one component of the plurality of components is distinguishable based on the first peak parameter includes: comparing a value of the first peak parameter included in peak information of a first component of the plurality of components with a value of the first peak parameter included in peak information of a component other than the first component among the plurality of pieces of peak information so as to determine whether or not there is a component for which a difference from the value of the first peak parameter of the first component is less than a first threshold value; when there is no component for which the difference is less than the first threshold value, determining that the first component is distinguishable based on the first peak parameter; and when there is a component for which the difference is less than the first threshold value, determining that the first component is not distinguishable based on the first peak parameter.

(Item 3) In the setting method according to item 1, the first peak parameter is a spectrum corresponding to a peak. The determining whether or not the one component of the plurality of components is distinguishable based on the first peak parameter includes: comparing a first spectrum included in peak information of a first component of the plurality of components with a spectrum included in peak information of a component other than the first component among the plurality of pieces of peak information so as to determine whether or not there is a spectrum for which a degree of similarity to the first spectrum is more than a second threshold value; when there is no spectrum for which the degree of similarity is more than the second threshold value, determining that the first component is distinguishable based on the first peak parameter; and when there is a spectrum for which the degree of similarity is more than the second threshold value, determining that the first component is not distinguishable based on the first peak parameter.

(Item 4) In the setting method according to any one of items 1 to 3, the setting to the other identification method includes: determining, based on a second peak parameter indicating a feature of a peak included in each of the plurality of pieces of the peak information, whether or not a second component that is not distinguishable based on the first peak parameter among the plurality of components is distinguishable from another component other than the second component and the component that is distinguishable based on the first peak parameter among the plurality of components; setting, to a second identification method that is based on the second peak parameter and that serves as the other identification method, an identification method for the second component that is distinguishable from the other component based on the second peak parameter; and setting, to a third identification method that serves as the other identification method, the identification method for the second component that is not distinguishable from the other component based on the second peak parameter.

With the setting method according to item 4, for each component peak, the identification method for the component that is distinguishable based on the other second peak parameter among the components that are not distinguishable from the other component based on the first peak parameter is set to the second identification method, and the identification method for the component that is not distinguishable based on the second peak parameter is set to the third identification method. Therefore, the number of types of identification methods that can be set is increased, with the result that a more appropriate identification method for each component can be set.

(Item 5) In the setting method according to any one of items 1 to 3, the target chromatogram is obtained by performing a chromatograph analysis onto the sample under an analysis condition different from an analysis condition employed when obtaining the reference chromatogram. The other identification method is a method that is based on a positional relation between a first reference peak and a second reference peak in the reference chromatogram, the first reference peak corresponding to a third component to which the first identification method is set, the second reference peak corresponding to a fourth component to which the other identification method is set. The other identification method is a method of identifying that a component for a second target peak included in the target chromatogram is the fourth component, the component for the second target peak being a component for which a positional relation with a first target peak associated with the third component among the plurality of target peaks included in the target chromatogram is a positional relation conforming to the positional relation between the first reference peak and the second reference peak.

With the setting method according to item 5, the identification method that is based on the relative positional relation is set to the component that cannot be identified based on the first peak parameter. Therefore, since the component that cannot be identified based on the first peak parameter can be associated in consideration of the relation with the other component, the identification method can be set to proceed the identification with high accuracy as compared with a case where the component is simply identified in accordance with the elution order or the like.

(Item 6) In the setting method according to any one of items 1 to 5, the plurality of target peaks respectively corresponding to the plurality of components are identified in accordance with a predefined identification order for the plurality of components. The setting method further includes determining the identification order so as to determine whether or not a component to which the first identification method is set is able to be identified, prior to the component to which the other identification method is set, with respect to one target peak of the plurality of target peaks.

With the setting method according to item 6, when associating the component to which the other identification method is set, the association of the component to which the first identification method is set has been finished, thereby narrowing down a candidate for the target peak to be associated with the component to which the other identification method is set. Therefore, an appropriate identification order for the identification method set to each component can be set.

(Item 7) In the setting method according to any one of items 1 to 6, the plurality of target peaks respectively corresponding to the plurality of components are identified in accordance with a predefined identification order for the plurality of components. The setting method further includes: receiving an input of the identification order; and determining the identification order so as to correspond to the received input of order.

With the setting method according to item 7, the identification order can be freely set by the user.

(Item 8) A setting device according to one aspect is a setting device for setting an identification method to each of a plurality of components. A plurality of target peaks respectively corresponds to the plurality of components and are included in a target chromatogram for an identification target, the plurality of target peaks are identified by determining whether or not each component corresponds to one target peak of the plurality of target peaks, based on a plurality of pieces of peak information respectively corresponding to the plurality of components and in accordance with the identification method set to each of the plurality of components, and the plurality of pieces of peak information are obtained from a reference chromatogram obtained by performing a chromatograph analysis onto a sample including the plurality of components. The setting device includes: a processor; and a memory that stores a program executable by the processor. The processor is configured to obtain the plurality of pieces of peak information, the processor is configured to determine whether or not one component of the plurality of components is distinguishable from another component other than the one component based on a value of a first peak parameter indicating a feature of a peak included in each of the plurality of pieces of peak information, the processor is configured to set, to a first identification method that is based on the first peak parameter, an identification method for a component that is distinguishable from the other component among the plurality of components based on the first peak parameter, and the processor is configured to set, to another identification method different from the first identification method, an identification method for a component that is not distinguishable from the other component among the plurality of components based on the first peak parameter.

(Item 9) A program according to one aspect causes a processor of a computer to perform the setting method according to any one of items 1 to 7.

With the setting device according to item 8 or the program according to item 9, the processor sets the identification method for each of the plurality of components based on the peak information of the component and in accordance with the predefined condition. Therefore, an appropriate identification method can be set in accordance with the feature of the peak corresponding to each component in the reference chromatogram without requiring trial and error by the user. As a result, the identification method can be readily set to each of the plurality of components.

The embodiments disclosed herein are also expected to be implemented in an appropriate combination unless technically inconsistent. Further, the embodiments disclosed herein are illustrative and non-restrictive in any respect. The scope of the present invention is defined by the terms of the claims, rather than the embodiments described above, and is intended to include any modifications within the scope and meaning equivalent to the terms of the claims.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A setting method executable by a computer to set an identification method to each of a plurality of components, wherein
a plurality of target peaks respectively corresponds to the plurality of components and are included in a target chromatogram for an identification target,
the plurality of target peaks are identified by determining whether or not each component corresponds to one target peak of the plurality of target peaks, based on a plurality of pieces of peak information respectively corresponding to the plurality of components and in accordance with the identification method set to each of the plurality of components, and
the plurality of pieces of peak information are obtained from a reference chromatogram obtained by performing a chromatograph analysis onto a sample including the plurality of components,
the setting method comprising:
obtaining the plurality of pieces of peak information;
determining whether or not one component of the plurality of components is distinguishable from another component other than the one component based on a value of a first peak parameter indicating a feature of a peak included in each of the plurality of pieces of peak information;
setting, to a first identification method that is based on the first peak parameter, an identification method for a component that is distinguishable from the other component among the plurality of components based on the first peak parameter; and
setting, to another identification method different from the first identification method, an identification method for a component that is not distinguishable from the other component among the plurality of components based on the first peak parameter.

2. The setting method according to claim 1, wherein
the determining whether or not the one component of the plurality of components is distinguishable based on the first peak parameter includes
comparing a value of the first peak parameter included in peak information of a first component of the plurality of components with a value of the first peak parameter included in peak information of a component other than the first component among the plurality of pieces of peak information so as to determine whether or not there is a component for which a difference from the value of the first peak parameter of the first component is less than a first threshold value,
when there is no component for which the difference is less than the first threshold value, determining that the first component is distinguishable based on the first peak parameter, and
when there is a component for which the difference is less than the first threshold value, determining that the first component is not distinguishable based on the first peak parameter.

3. The setting method according to claim 1, wherein
the first peak parameter is a spectrum corresponding to a peak,
the determining whether or not the one component of the plurality of components is distinguishable based on the first peak parameter includes
comparing a first spectrum included in peak information of a first component of the plurality of components with a spectrum included in peak information of a component other than the first component among the plurality of pieces of peak information so as to determine whether or not there is a spectrum for which a degree of similarity to the first spectrum is more than a second threshold value,
when there is no spectrum for which the degree of similarity is more than the second threshold value, determining that the first component is distinguishable based on the first peak parameter, and
when there is a spectrum for which the degree of similarity is more than the second threshold value, determining that the first component is not distinguishable based on the first peak parameter.

4. The setting method according to claim 1, wherein
the setting to the other identification method includes
determining, based on a second peak parameter indicating a feature of a peak included in each of the plurality of pieces of the peak information, whether or not a second component that is not distinguishable based on the first peak parameter among the plurality of components is distinguishable from another component other than the second component and the component that is distinguishable based on the first peak parameter among the plurality of components,
setting, to a second identification method that is based on the second peak parameter and that serves as the other identification method, an identification method for the second component that is distinguishable from the other component based on the second peak parameter, and
setting, to a third identification method that serves as the other identification method, the identification method for the second component that is not distinguishable from the other component based on the second peak parameter.

5. The setting method according to claim 1, wherein
the target chromatogram is obtained by performing a chromatograph analysis onto the sample under an analysis condition different from an analysis condition employed when obtaining the reference chromatogram,
the other identification method is a method that is based on a positional relation between a first reference peak and a second reference peak in the reference chromatogram, the first reference peak corresponding to a third component to which the first identification method is set, the second reference peak corresponding to a fourth component to which the other identification method is set, and
the other identification method is a method of identifying that a component for a second target peak included in the target chromatogram is the fourth component, the component for the second target peak being a component for which a positional relation with a first target peak associated with the third component among the plurality of target peaks included in the target chromatogram is a positional relation conforming to the positional relation between the first reference peak and the second reference peak.

6. The setting method according to claim 1, wherein
the plurality of target peaks respectively corresponding to the plurality of components are identified in accordance with a predefined identification order for the plurality of components,
the setting method further comprising determining the identification order so as to determine whether or not the component to which the first identification method is set is able to be identified, prior to the component to which the other identification method is set, with respect to one target peak of the plurality of target peaks.

7. The setting method according to claim 1, wherein
the plurality of target peaks respectively corresponding to the plurality of components are identified in accordance with a predefined identification order for the plurality of components,
the setting method further comprising:
receiving an input of the identification order; and
determining the identification order so as to correspond to the received input of order.

8. A setting device for setting an identification method to each of a plurality of components, wherein
a plurality of target peaks respectively corresponds to the plurality of components and are included in a target chromatogram for an identification target,
the plurality of target peaks are identified by determining whether or not each component corresponds to one target peak of the plurality of target peaks, based on a plurality of pieces of peak information respectively corresponding to the plurality of components and in accordance with the identification method set to each of the plurality of components, and
the plurality of pieces of peak information are obtained from a reference chromatogram obtained by performing a chromatograph analysis onto a sample including the plurality of components,
the setting device comprising:
a processor; and
a memory that stores a program executable by the processor, wherein
the processor is configured to obtain the plurality of pieces of peak information,
the processor is configured to determine whether or not one component of the plurality of components is distinguishable from another component other than the one component based on a value of a first peak parameter indicating a feature of a peak included in each of the plurality of pieces of peak information,
the processor is configured to set, to a first identification method that is based on the first peak parameter, an identification method for a component that is distinguishable from the other component among the plurality of components based on the first peak parameter, and
the processor is configured to set, to another identification method different from the first identification method, an identification method for a component that is not distinguishable from the other component among the plurality of components based on the first peak parameter.
